(19) United States
(12) Patent Application Publication
(10) Pub. No.: US 2012/0292546 A1
(43) Pub. Date: Nov. 22, 2012

(54) MULTI-POSITION VALVE ASSEMBLIES

(76) Inventor: Timothy Collin Wheatley, Beverly, MA (US)

(21) Appl. No.: 13/108,300

(22) Filed: May 16, 2011

(51) Int. Cl. F16K 25/00; F16K 43/00

(52) U.S. Cl. 251/186; 137/15.18

(57) ABSTRACT

A multi-position valve assembly includes a valve body member at least partially defining a body chamber and a body orifice providing an inlet for ingress of a product into the body chamber. A stem member includes a plug portion at least partially located in the body chamber and a stem portion extending vertically from the plug portion beyond a top of the body chamber. The stem member includes a stem outlet capable of communication with the body chamber via a stem orifice. A first biasing member biases the stem member toward a closed position. A second biasing member biases the stem member toward the closed position only after the stem member is moved a clearance gap to a first open position.

### TECHNICAL FIELD

The present specification generally relates to container pressurizing and sealing apparatus and methods of pressurizing containers.

### BACKGROUND

Liquid personal care products are available in a wide variety of containers, including bottles, jars, tubes, and cans. One exemplary container is an aerosol container, such as piston in can or bag on valve type container. For bag on valve containers, as one example, a flexible bag may be attached to an aerosol valve. The flexible bag may be filled with a product that is to be dispensed by the consumer. The container may be filled with a propellant between the flexible bag and inside wall of the container. When the aerosol valve is actuated, the propellant forces the product from the bag and through the aerosol valve. Exemplary containers include those disclosed in U.S. Pat. Nos. 7,810,675, 6,923,342, 6,874,544, 6,789,702, 6,622,943, 6,415,800, 6,405,898, 6,250,505, 5,385,303, 4,402,427, 4,122,978 and U.S. application Ser. Nos. 11/405,320, 11/405,288, 11/405,046 and 11/405,295.

### SUMMARY

In one embodiment, a multi-position valve assembly includes a valve body member at least partially defining a body chamber and a body orifice providing an inlet for ingress of a product into the body chamber. A stem member includes a plug portion at least partially located in the body chamber and a stem portion extending vertically from the plug portion beyond a top of the body chamber. The stem member includes a stem outlet capable of communication with the body chamber via a stem orifice. A first biasing member biases the stem member toward a closed position. A second biasing member biases the stem member toward the closed position only after the stem member is moved a clearance gap to a first open position.

In another embodiment, a method of providing a multi-position valve assembly is provided. The method includes locating a stem member including a plug portion at least partially within a body chamber of a valve body member. The valve body member includes a body orifice providing an inlet for ingress of a product into the body chamber. The stem member includes a stem outlet capable of communication with the body chamber via a stem orifice. The stem member is biased toward a closed position using a first biasing member in contact with the stem member with the stem member in the closed position. A second biasing member is provided that biases the stem member toward the closed position only after the stem member is moved a clearance gap to a first open position.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a diagrammatic section view of an embodiment of a container including a valve cup assembly;

FIG. 2 is a side section view of the valve cup assembly of FIG. 1;

FIG. 3 is a diagrammatic side section view of an embodiment of a valve assembly in a closed configuration for use in the valve cup assembly of FIG. 2;

FIG. 4 is a diagrammatic side section view of the valve assembly of FIG. 3 in a first open configuration;

FIG. 5 is a diagrammatic side section view of the valve assembly of FIG. 3 in a second open configuration;

FIG. 6 is a side section view of another embodiment of a valve cup assembly;

FIG. 7 is a diagrammatic side section view of an embodiment of a valve assembly in a closed configuration for use in the valve cup assembly of FIG. 6;

FIG. 8 is a diagrammatic side section view of the valve assembly of FIG. 7 in a first open configuration; and

FIG. 9 is a diagrammatic side section view of the valve assembly of FIG. 7 in a second open configuration.

### DETAILED DESCRIPTION

Embodiments described herein generally relate to container valve assemblies that facilitate user control of the flow of a liquid, gas, or other material through the valve assemblies. The valve assemblies include multiple biasing members that are arranged to require differing opening pressures when actuating the valve assemblies to provide multiple, discrete opening positions. Such multi-position valve assemblies can allow user control of the opening of a fluid passageway to a stem orifice of the valve assemblies, which, in turn, can be used to control the delivery rate of the product through the valve assemblies.

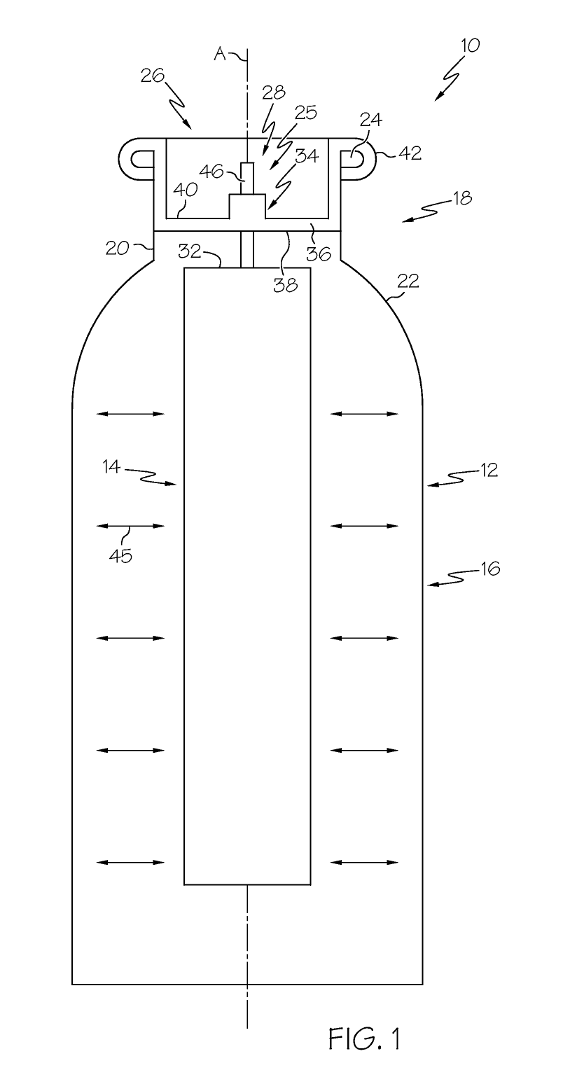

Referring to FIG. 1, an exemplary pressurized container assembly 10 includes an outer container 12 and an inner container 14 disposed within the outer container 12. The outer container 12 may include a body portion 16 and a top portion 18 that extends upwardly from the body portion 16. The top portion 18 includes a neck 20 that extends upwardly from a shoulder 22 of the body portion 16 to a mouth 25. The shoulder 22 extends inwardly toward a central axis A of the outer container 12 to provide a narrowing transition between the larger width dimension of the body portion 16 and the narrower width dimension of the neck 20. An upper lip flange 24 is provided about an upper opening 26 of the outer container 12. The upper lip flange 24 may provide connection structure for connecting a valve cup assembly 28 to the outer container 12.

The outer container 12 may be rigid. By rigid, it is meant that the outer container 12 does not substantially change shape or size in response to normal usage forces or depletion of the contents of the pressurized container assembly 10. A rigid outer container 12 may allow the pressurized container assembly 10 to be conveniently shipped, stored, displayed, placed on a tabletop, etc. Furthermore, a rigid outer container 12 can provide protection in the event that the pressurized container assembly 10 is dropped, or otherwise disturbed. In other embodiments, the outer container may not be formed by a rigid material. For example, the outer container 12 may become more and more flexible as the contents of the pressurized container assembly 10 are depleted. Suitable materials for the outer container 12 may include metals, plastics, glass and combinations thereof of any wall thickness suitable for the intended pressurization.

The inner container 14 may generally be formed of a material more flexible than the outer container 12 and includes an end 32 that is connected to a valve assembly 34 of the valve cup assembly 28. The inner container 14 may be connected to the valve assembly 34 so that a product located in the inner container 14 can be dispensed through the valve assembly 34, when the valve assembly 34 is actuated. While a pressurized container is shown, non-pressurized containers may also be employed. For example, potential energy associated with an energy band may be used. In some embodiments, a dip tube may be used instead of an inner container.

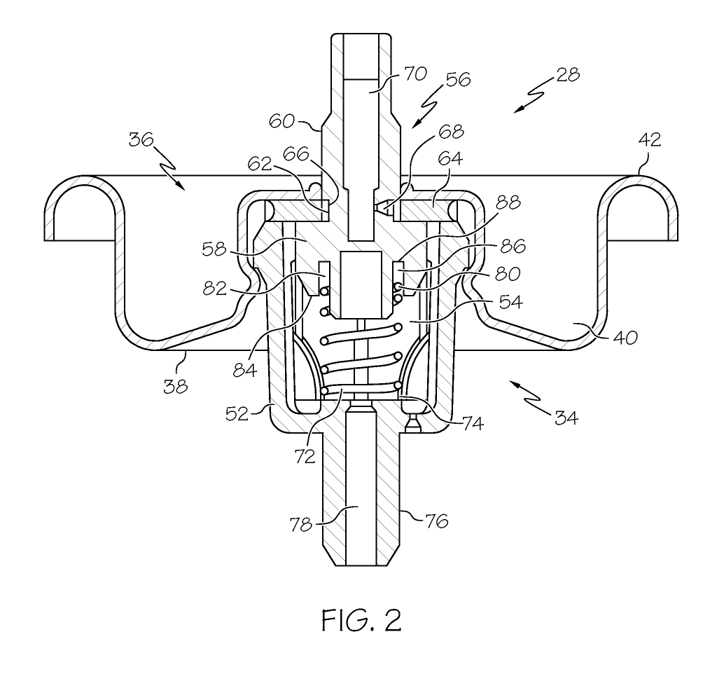

Referring also to FIG. 2, the exemplary valve cup assembly 28 includes a valve cup 36 having a cup bottom 38, a cup top 40 and a cup flange 42 extending around a periphery of the cup top 40. A gasket (not shown) may be optionally provided with the cup flange 42 to aid in forming a seal between the valve cup assembly 28 and the outer container 12. As can be seen in FIG. 1, the cup flange 42 is crimped around the upper lip flange 24 of the outer container 12. This crimping can form the fluid-tight seal between the valve cup assembly 28 and the outer container 12. The valve cup 36 may be formed of any suitable material such as metals and thermoplastics. One suitable metal for forming the valve cup 36 includes steel.

The valve cup assembly 28 can be inserted into or outside of the mouth 25 of the outer container 12. While crimping is described above, the valve cup assembly 28 may be joined to the container mouth 25 in any suitable fluid tight or vapor tight manner, sufficient to withstand internal (represented by arrows 45) or external pressurization of the pressurized container assembly 10. A press fit, interference fit, clearance fit may be utilized for joining the mouth 25 and valve cup assembly 28. Joining may also be accomplished by friction welding, solvent welding, high frequency welding, adhesive, or a combination thereof. If desired, an intermediate material or component may be disposed between the valve cup assembly 28 and mouth 25, so long as such material or component provides an adequate seal.

Referring to FIG. 2, the valve assembly 34 includes a valve body member 52 that at least partially defines a body chamber 54. A stem member 56 is partially located within the body chamber 54. The stem member 56 includes a plug portion 58 located within the body chamber 54 and a stem portion 60 that extends through an opening 62 in the valve cup 36 and vertically above the cup top 40 to which an actuator may be connected.

A sealing member 64 (e.g., a gasket) is located between the valve body member 52 and the valve cup 36. The sealing member 64 may be any device/component that seals the stem portion 60 at rest and unseals the stem portion 60 when disturbed during an actuation operation. The sealing member 64 includes an opening 66 through which the stem portion 60 extends. The sealing member 64 provides a seal in a closed position as shown by FIG. 2 to prevent product from entering a stem orifice 68 that is in communication with a stem outlet 70. The sealing member 64 may be formed of a resiliently flexible material such as rubber or plastic.

A spring 72 is seated against a floor 74 of the body chamber 54, above a downwardly extending tailpiece 76 that includes a body orifice 78 leading to the body chamber 54 for ingress of product into the body chamber 54. The spring can be any type of structure which provides a mechanical return force when deformed from its rest position. In some embodiments, the spring may be a leaf spring, a coil or a compressible elastomeric structure. The spring may also be structures such as a flange that extends outwardly from the stem member 56 and/or inwards from the valve cup 36. The spring 72 includes an upper contacting end 80 that is slidingly received within a recess 82 formed in a bottom 84 of the plug portion 58. As can be seen, with the valve assembly 34 in the illustrated closed position, a clearance gap 86 or distance is provided between the contacting end 80 of the spring 72 and a seating surface 88 within the recess 82 of the plug portion 58. As will be described in greater detail below, the contacting end 80 of the spring 72 is offset the clearance gap 86 from the seating surface 88 such that the seating surface 88 engages the contacting end 80 only after the stem member 56 is depressed the clearance gap 86. In other embodiments, the clearance gap may be between the floor 74 and the spring 72, for example, by affixing the spring 72 to the surface 88, for example, by friction or any other suitable connection.

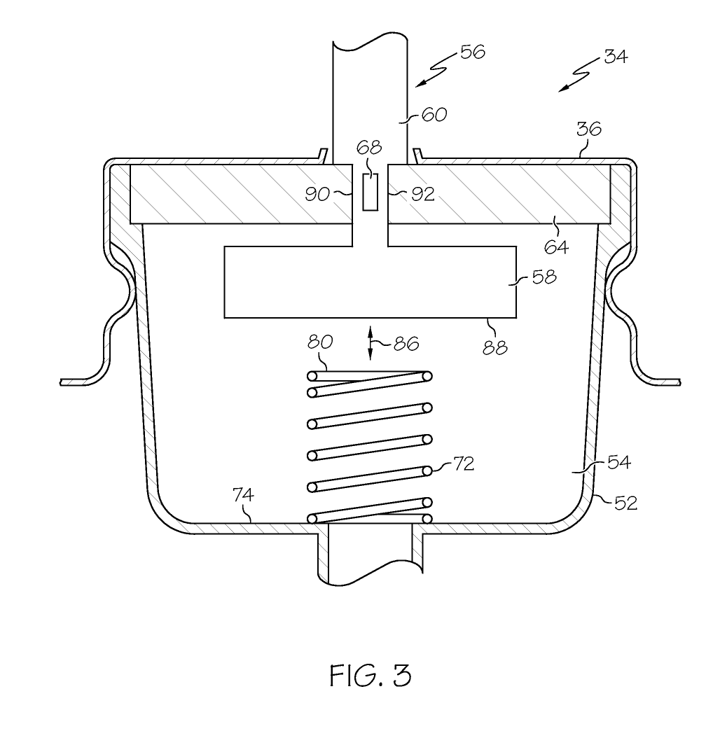

Referring to FIG. 3, the valve assembly 34 is shown diagrammatically in its closed position to illustrate its operation. The valve assembly 34 includes the valve body member 52, the stem member 56 with the plug portion 58 located within the body chamber 54 and the stem portion 60 extending through the valve cup 36 and the sealing member 64 disposed around the stem portion 60. In the illustrated example, the stem portion 60 includes an annular notch 90 of reduced outer dimension that extends about the periphery of the stem portion 60 and that has a height that is sized to receive an inner surface 92 of the sealing member 64. The spring 72 is seated against the floor 74 of the body chamber 54. As above discussed above, the clearance gap 86 is provided between the contacting end 80 of the spring 72 and the seating surface 88 of the plug portion 58.

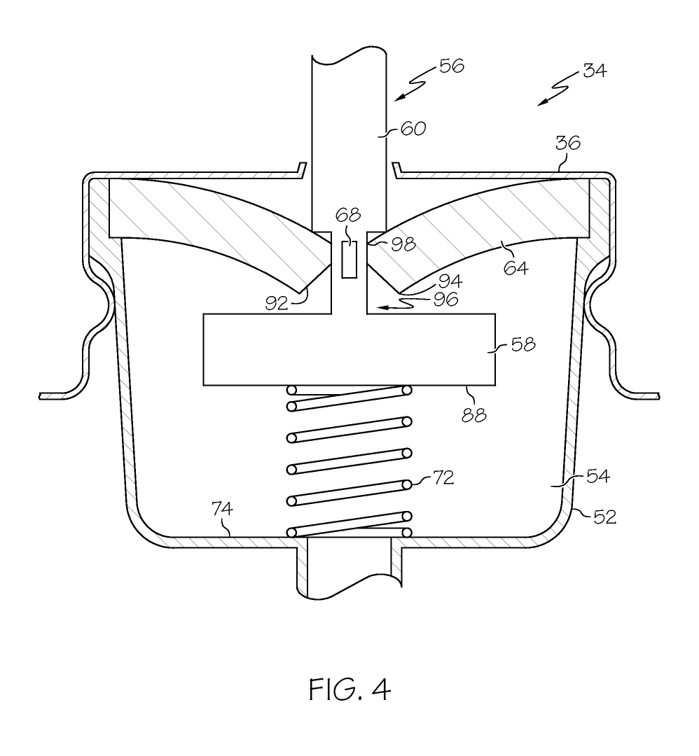

Referring now to FIG. 4, the valve assembly 34 is illustrated in a first “On-low” open position. When the stem member 56 is initially depressed by the user, there is no resistance supplied by the spring 72 due to the clearance gap 86 between the spring 72 and the seating surface 88 (FIG. 3). Instead, the resistance is supplied by the sealing member 64, which resiliently deforms toward the floor 74 of the body chamber 54 as the stem member 56 is depressed. Thus, a relatively low actuation force (e.g., up to about two pounds, such as between about 0.5 pounds and about two pounds) is required to place the valve assembly 34 in the first open position. The force applied by the sealing member is given by:

Applied Force=k₁X₁,

where k₁ is the spring constant of the sealing member; and X₁ is the distance moved toward the first open position.

In the first open position, the seating surface 88 engages the spring 72, which provides tactile feedback to the user that the valve assembly 34 is in the first open position due to the increased resistance provided by the two biasing members (i.e., the spring 72 as the second biasing member and the sealing member 64 as the first biasing member). As can be seen by FIG. 4, in this first open position, a lower edge 94 of the inner surface 92 disengages and is drawn away from the stem portion 60. This can create a fluid passageway 96 leading to the stem orifice 68. In some embodiments, only a portion of the stem orifice 68 is open to the fluid passageway 96 as an upper edge 98 of the inner surface 92 remains engaged with the stem portion 60 thereby blocking a portion of the stem orifice 68 from the fluid passageway 96.

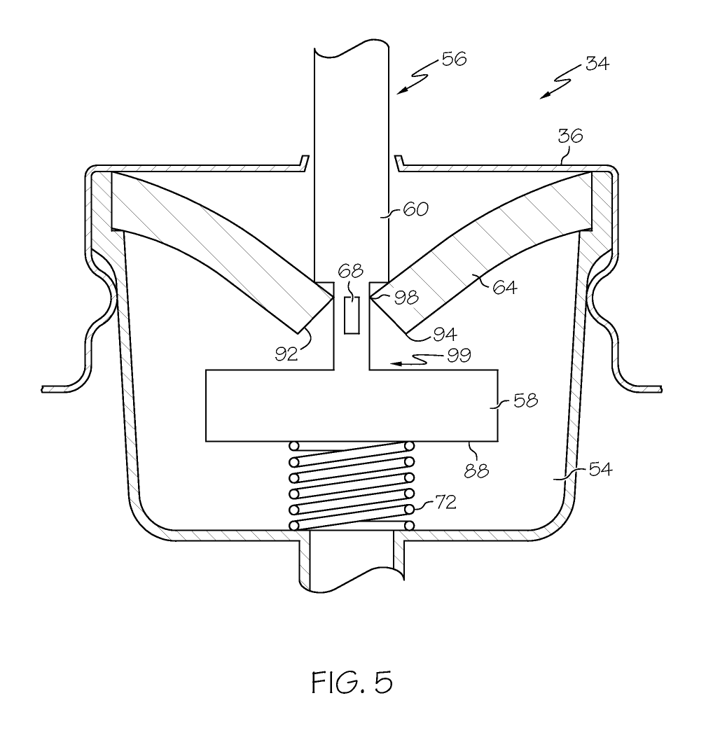

Referring to FIG. 5, the valve assembly 34 is illustrated in a second “On-high” open position where the stem member 56 is depressed beyond the first open position. When the stem member 56 is depressed beyond the first open position by the user, there is increased resistance supplied by the spring 72. Here, the resistance is being supplied by both the sealing member 64 and the spring 72. In some embodiments, the spring constant of the spring 72 may be selected to provide a noticeable bump in the amount of actuation force required to depress the stem member 56 beyond the first open position. Thus, a relatively high actuation force (e.g., greater than about two pounds, such as from about two pounds to about 10 pounds, such as between about three and six pounds) is required to place the valve assembly 34 in the second open position. The force applied by both the sealing member 64 and the spring is given by:

Applied Force=k₁(X₁+X₂)+k₂X₂,

where k₁ is the spring constant of the sealing member;

k₂ is the spring constant of the spring; X₁ is the distance to the first open position; and

X₂ is the distance moved from the first position.

During movement beyond the first open position to the second open position, the seating surface 88 depresses the spring 72, which increases the resistance provided. As can be seen by FIG. 5, in the second open position, the lower edge 94 of the inner surface 92 of the sealing member 64 is further drawn away from the stem portion 60. This can create a larger fluid passageway 99 between the sealing member 64 and the stem portion 60 leading to the stem orifice 68 compared to the fluid passageway 96 provided with the valve assembly 34 in the first open position. In some embodiments, the entire stem orifice 68 is open to the fluid passageway 99. The upper edge 98 of the inner surface 92 may remain engaged with the stem portion 60 with the valve assembly 34 in the second open position. In other embodiments, only a portion of the stem orifice 68 is open to the fluid passageway 96 as an upper edge 98 of the inner surface 92 may remain engaged with the stem portion 60 thereby blocking a portion of the stem orifice 68 from the fluid passageway 99. In such embodiments, the stem orifice 68 may be opened an amount that is greater than the amount it is opened in the first open position.

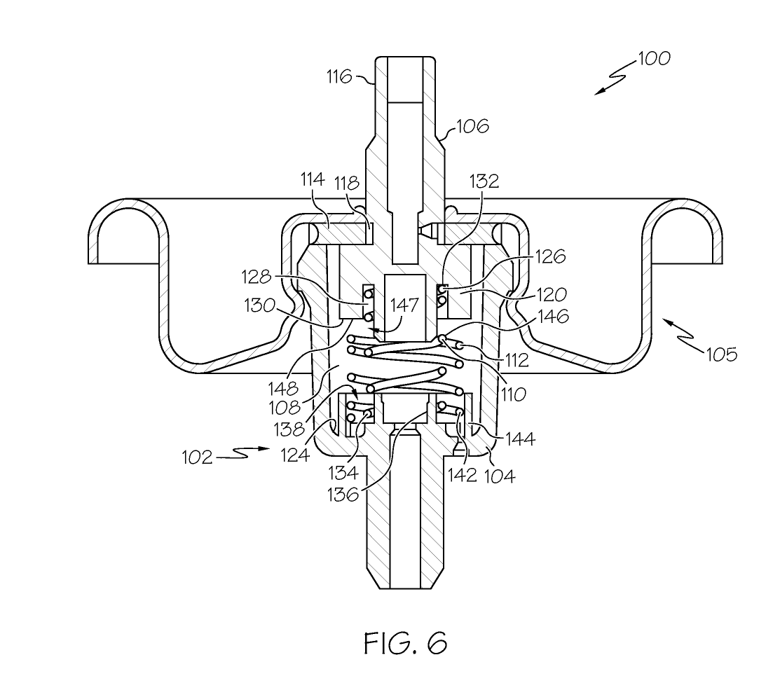

Referring now to FIG. 6, another valve cup assembly 100 includes a valve assembly 102 that includes multiple biasing members for providing multiple opening positions. The valve cup assembly 100, in this embodiment, includes many of the same or similar components as the valve cup assembly 28 including a valve cup 105, a valve body member 104 and a stem member 106 partially located in the body chamber 108. A sealing member 114 (e.g., a gasket) is located between the valve body member 104 and the valve cup 105 and receives a stem portion 116 of the stem member 106 through an opening 118. A plug portion 120 of the stem member 106 is located in the body chamber 108. In this embodiment, multiple springs 110 and 112 along with the sealing member 114 are provided as biasing members that are used to provide the multiple opening positions. In another embodiment, more than two springs can be used. The springs can be of different designs (leaf vs. coil spring), or can be the same spring type with the same or different amounts of resistance and/or height.

The first spring 110 extends between a floor 124 of the valve body member 104 and the plug portion 120 of the stem member 106. In some embodiments, a bottom end 134 of the first spring 110 is received about a spring locating support 136 located in a spring housing recess 138 at the floor 124. A contacting end 126 of the first spring 110 may be received within a recess 128 formed in a bottom 130 of the plug portion 120. In this embodiment, no clearance gap is provided between the contacting end 126 of the first spring 110 and a seating surface 132 located within the recess 128. Instead, the first spring 110 may be engaged with the seating surface 132 with the valve assembly 102 in the illustrated closed position.

The second spring 112 extends between the floor 124 of the valve body member 104 and the plug portion 120 of the stem member 106. In some embodiments, a bottom end 142 of the second spring 112 is received within a spring wall support 144 providing an outer wall for the spring housing recess 138 at the floor 124. A contacting end 146 of the second spring 112 may be located outside the recess 128 formed in the bottom 130 of the plug portion 120. As can be seen, with the valve cup assembly 100 in the illustrated closed position, a clearance gap 147 or distance is provided between the contacting end 146 of the second spring 112 and an outer seating surface 148 located outside the recess 128 of the plug portion 120. The contacting end 146 of the second spring 112 is offset the clearance gap 147 from the outer seating surface 148 such that the outer seating surface 148 engages the contacting end 146 only after the stem member 106 is depressed the clearance gap 147.

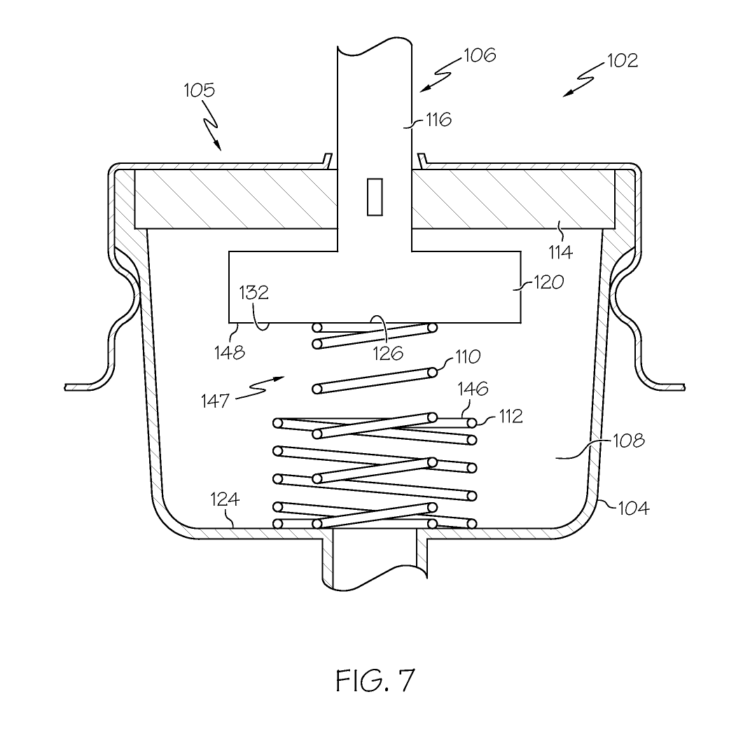

Referring to FIG. 7, valve assembly 102 of the valve cup assembly 100 is shown diagrammatically in its closed position to illustrate its operation. The valve assembly 102 includes the valve body member 104, the stem member 106 with the plug portion 120 located within the body chamber 108 and the stem portion 116 extending through the valve cup 105 and the sealing member 114 disposed around the stem portion 116. In the illustrated example, the stem portion 116 may or may not include an annular notch of reduced outer dimension that extends about the periphery of the stem portion 116 and that has a height that is sized to receive the sealing member 114 (as illustrated in FIG. 3). The first and second springs 110 and 112 are seated against the floor 124 of the body chamber 108. As above discussed above, the contacting end 126 of the first spring 110 engages the seating surface 132 and the contacting end 146 of the second spring 112 is offset vertically from the seating surface 148 (here the seating surfaces 132 and 148 coextend with one another for simplicity) the clearance gap 147.

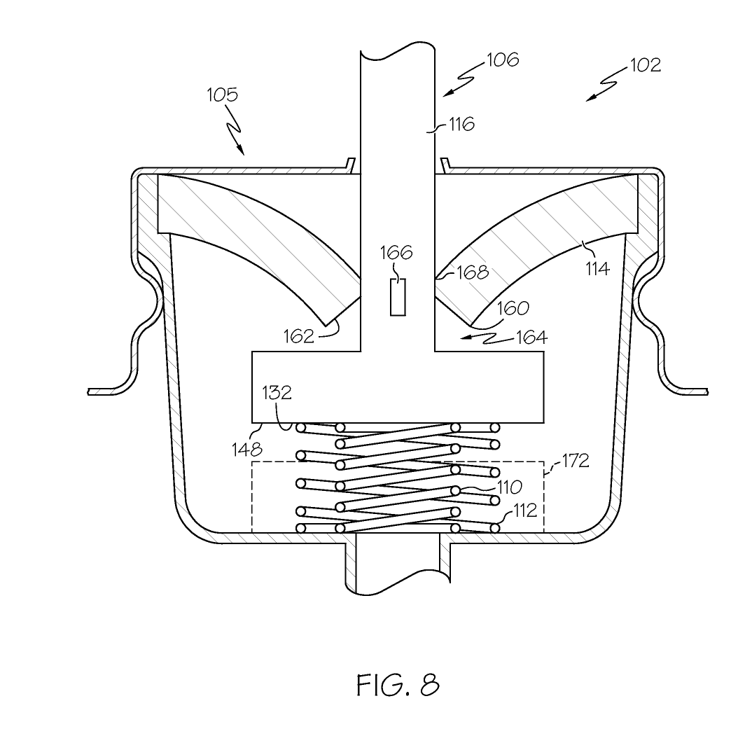

Referring now to FIG. 8, the valve assembly 102 is illustrated in a first “On-low” open position. When the stem member 106 is initially depressed by the user, there is no resistance supplied by the second spring 112 due to the clearance gap 147 (FIG. 7) between the second spring 112 and the seating surface 148. Instead, the resistance is being supplied by the sealing member 114 and the first spring 110 as the stem member 106 is depressed. Thus, a relatively low actuation force is required to place the valve assembly 102 in the first open position. The force applied by the sealing member and the first spring is given by:

Applied Force=(k₁+k₂)X₁,

where k₁ is the spring constant of the sealing member;

k₂ is the spring constant of the first spring; and

X₁ is the distance moved toward the first open position.

In the first open position, the seating surface 148 engages the second spring 112, which provides tactile feedback to the user that the valve assembly 102 is in the first open position due to the increased resistance provided by the three biasing members (i.e., the first spring 110, the second spring 112 and the sealing member 114). As can be seen by FIG. 8, in this first open position, a lower edge 160 of an inner surface 162 of the sealing member 114 disengages and is drawn away from the stem portion 116. This can create a fluid passageway 164 leading to stem orifice 166. In some embodiments, only a portion of the stem orifice 166 is open to the fluid passageway 164 as an upper edge 168 of the inner surface 162 remains engaged with the stem portion 116 thereby blocking a portion of the stem orifice 166 from the fluid passageway 164.

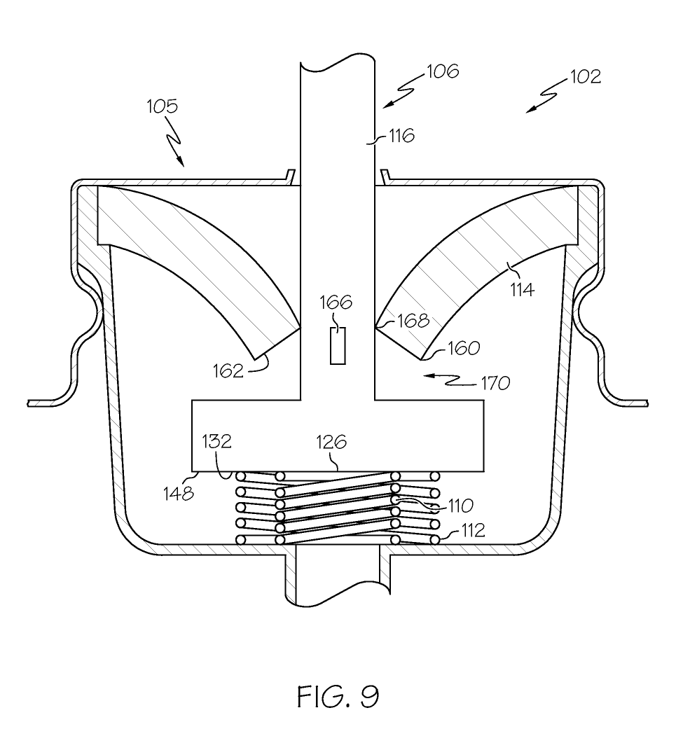

Referring to FIG. 9, the valve assembly 102 is illustrated in a second “On-high” open position where the stem member 106 is depressed beyond the first open position. When the stem member 106 is depressed beyond the first open position by the user, there is increased resistance supplied by the second spring 112. Here, the resistance is being supplied by the sealing member 114, the first spring 110 and the second spring 112. In some embodiments, the spring constant of the second spring 112 may be selected to provide a noticeable increase or bump in the amount of actuation force required to depress the stem member 106 beyond the first open position. Thus, a relatively high actuation force (e.g., between about five pounds and about eight pounds) is required to place the valve assembly 102 in the second open position. The force applied by the sealing member, the first spring and the second spring is given by:

Applied Force=(k₁+k₂)(X₁+X₂)+k₃X₂,

where k₁ is the spring constant of the sealing member;

k₂ is the spring constant of the first spring;

k₃ is the spring constant of the second spring;

X₁ is the distance to the first open position;

and X₂ is the distance moved from the first position.

During movement beyond the first open position to the second open position, the seating surface 148 engages and depresses the second spring 112, which increases the resistance provided. As can be seen by FIG. 9, in the second open position, the lower edge 160 of the inner surface 162 of the sealing member 114 is further drawn away from the stem portion 116. This can create a larger fluid passageway 170 between the sealing member 114 and the stem portion 116 leading to the stem orifice 166 compared to the fluid passageway 164 provided with the valve assembly 102 in the first open position. In some embodiments, the entire stem orifice 166 is open to the fluid passageway 170. The upper edge 168 of the inner surface 162 may remain engaged with the stem portion 116 with the valve assembly 102 in the second open position. In other embodiments, only a portion of the stem orifice 166 is open to the fluid passageway 170 as an upper edge 168 of the inner surface 162 may remain engaged with the stem portion 116 thereby blocking a portion of the stem orifice 166 from the fluid passageway 170. In such embodiments, the stem orifice 166 may be opened an amount that is greater than the amount it is opened in the first open position.

While two open positions are discussed above, there may be more than two open positions, such as three open positions (e.g., “On-low”, “On-medium” and “On-high”) or more. Referring again to FIG. 8, as one example, a third spring 172 (represented by dotted lines) may be provided that is offset a clearance gap from the engaging surface that is greater than the clearance gap 147 (FIG. 7). In this embodiment, force applied by the sealing member, the first spring, the second spring and the third spring is given by:

Applied Force=(k₁+k₂)(X₁+X₂+X₃)+k₃(X₂+X₃)+k₄X₃,

where k₁ is the spring constant of the sealing member;

k₂ is the spring constant of the first spring;

k₃ is the spring constant of the second spring;

k₄ is the spring constant of the third spring;

X₁ is the distance to the first open position;

X₂ is the distance to the second open position; and

X₃ is the distance moved toward the third open position.

The valve assemblies described herein may be used with a number of packaged compositions such as pressurized dispensers including, for example, personal care products (e.g., cosmetics, antiperspirants/deodorants, skin care products, shave care products, fragrances, and hair care products), home care products, air care products, and pet care products. By providing valve assemblies having multiple positions as described above, a controlled release profile can be achieved by positioning the valve stem in various discrete open positions. For example, during use, it may be desirable for a user to place the valve assemblies described above in the first open position at initial use when the dispensing pressure within the containers may be at a peak. This can reduce the dispensing rate of the product through the valve assemblies compared to fully opening the valve assemblies. As the product is dispensed over time, it may become desirable for a user to place the valve assemblies in the second open position when the dispensing pressure within the containers is reduced (e.g., due to the reduction of volume of an inner bag). This can increase the dispensing rate of the product compared to if the valve assemblies were in their first open positions and can accommodate for the reduction in the dispensing pressure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-position valve assembly, comprising:
a valve body member at least partially defining a body chamber and a body orifice providing an inlet for ingress of a product into the body chamber;
a stem member including a plug portion at least partially located in the body chamber and a stem portion extending vertically from the plug portion beyond a top of the body chamber, the stem member including a stem outlet capable of communication with the body chamber via a stem orifice;
a first biasing member that biases the stem member toward a closed position; and
a second biasing member that biases the stem member toward the closed position only after the stem member is moved a clearance gap to a first open position.

2. The valve assembly of claim 1, wherein the first biasing member comprises a sealing member comprising a resiliently flexible material.

3. The valve assembly of claim 2, wherein the sealing member includes an inner wall defining an opening through which the stem portion extends.

4. The valve assembly of claim 3, wherein the stem portion includes a notch that extends about a periphery of the stem portion, the notch receiving the inner wall of the sealing member.

5. The valve assembly of claim 2 further comprising a valve cup connected to the valve body member, the valve cup including a valve cup opening through which the stem portion extends.

6. The valve assembly of claim 5, wherein the sealing member is located between a lower surface of the valve cup and a seating surface of the valve body member forming an at least partial seal therebetween.

7. The valve assembly of claim 2, wherein the second biasing member comprises a spring located within the body chamber.

8. The valve assembly of claim 7, wherein the spring has a spring constant that is different than or substantially the same as a spring constant of the sealing member.

9. The valve assembly of claim 7, wherein the spring has a stem member contacting end that is offset the clearance gap from a seating surface of the stem member that engages the contacting end of the spring when the stem member is moved the clearance gap toward the first open position.

10. The valve assembly of claim 7, wherein, at the first open position, the stem member engages the spring and a fluid passageway is provided to the stem orifice to allow product to enter the stem orifice.

11. The valve assembly of claim 10, wherein, as the stem member is moved beyond the first open position toward a second open position, the fluid passageway increases in size to allow the product to enter the stem orifice.

12. The valve assembly of claim 11, wherein no more than about two pounds of force is required to place the stem member in the first open position and greater than about two pounds of force is required to place the stem member in the second open position.

13. The valve assembly of claim 1, wherein the first biasing member comprises a first helical spring and the second biasing member comprises a second helical spring.

14. The valve assembly of claim 13, wherein the first helical spring and the second helical spring have different or substantially the same spring constants.

15. A method of providing a multi-position valve assembly, the method comprising:
locating a stem member including a plug portion at least partially within a body chamber of a valve body member, the valve body member including a body orifice providing an inlet for ingress of a product into the body chamber, the stem member including a stem outlet capable of communication with the body chamber via a stem orifice;
biasing the stem member toward a closed position using a first biasing member in contact with the stem member with the stem member in the closed position; and
providing a second biasing member that biases the stem member toward the closed position only after the stem member is moved a clearance gap to a first open position.

16. The method of claim 15, wherein the first biasing member comprises a sealing member comprising a resiliently flexible material, the sealing member including an inner wall defining an opening through which a stem portion of the stem member extends.

17. The method of claim 14 further comprising connecting a valve cup to the valve body member, the valve cup including a valve cup opening through which the stem portion extends.

18. The method of claim 17 further comprising locating the sealing member between a lower surface of the valve cup and a seating surface of the valve body member forming an at least partial seal therebetween.

19. The method of claim 16, wherein the second biasing member comprises a spring located within the body chamber.

20. The method of claim 19, wherein, at the first open position, the stem member engages the spring and a fluid passageway is provided to the stem orifice to allow product to enter the stem orifice, wherein, moving the stem member beyond the first open position increases a size of the fluid passageway to allow the product to enter the stem orifice.
